(19) United States
(12) Patent Application Publication
(10) Pub. No.: US 2017/0172111 A1
(43) Pub. Date: Jun. 22, 2017

(54) Bird Feeder

(71) Applicant: Petface Limited, Stotfold, Hertfordshire (GB)

(72) Inventor: Adam Bowler, Harpenden, Hertfordshire (GB)

(73) Assignee: Petface Limited, Stotfold, Hertfordshire (GB)

(21) Appl. No.: 15/320,610

(22) PCT Filed: Jun. 2, 2015
(86) PCT No.: PCT/GB2015/051602

§ 371 Date: Dec. 20, 2016

(30) Foreign Application Priority Data
Jun. 20, 2014 (GB) 1411038.1

(51) Int. Cl. A01K 39/012

(52) U.S. Cl. CPC A01K 39/012

(57) ABSTRACT

A device for feeding birds is described in which the handle of the device is used to actuate a one-step locking and closing mechanism of the lid of the device by movement between a first and second position. In the first position, the lid is urged onto the container and in the second position, the lid is released from the container allowing access thereto.

### FIELD OF INVENTION

The present invention relates to a device for feeding birds, in particular hanging devices for feeding birds.

### BACKGROUND

Hanging bird feeders typically comprise a container for storing bird feed which may comprise a mixture of seeds, a lid to retain the seeds within the bird feeder, and a handle which is used to hang the bird feeder from a tree, for example. However, in past devices, the lid has not been secured to the container, allowing larger animals such as squirrels to access the container and remove the bird feed leaving the container empty for birds, and rendering the container unhygienic and the feed unprotected because it is open to the elements.

Document GB2489059 describes a bird feeder comprising a lid which is held over the container by a pivotable handle.

However, the device of document GB2489059 comprises a relatively complex movement to operate which involves a two-step motion to release the lid from the container, firstly a downwards movement of the handle and secondly a pivoting movement of the handle. Furthermore, the lid is merely resting upon the container and is only blocked from lateral movement by the handle, the lid is still easily removed from the container by vertical force.

Document U.S. Pat. No. 6,584,932 also describes a bird feeder comprising a lid which is prevented from complete removal by a pivotable handle.

However, the device of document U.S. Pat. No. 6,584,932 comprises a simplistic mechanism whereby the lid is blocked only from vertical movement by projections on the handle. The lid is not secured in the lateral direction, nor is

the lid held down onto the container, it is merely rested upon the container and can easily be removed.

Therefore, it is at least an object of one of the aspects of the present invention to address one or more of the aforementioned problems.

### SUMMARY OF THE DISCLOSURE

According to a first aspect of the present invention, there is provided a device for feeding birds comprising a container, a handle and a lid, the handle being pivotally connected to the container and having a first position and a second position, wherein in the first position the handle engages the lid such that the lid is urged onto the container, and in the second position the handle disengages from the lid such that the lid is removable from the container.

Advantageously, the device acts to exert force on the lid when the handle is engaged in the first position such that the lid is more securely retained upon the container and cannot be removed by other animals from any direction of force, including lateral or vertical. Additionally ingress by weather elements, which degrade the bird feed, are substantially reduced or eliminated by having a secure lid. Furthermore, the device is operated by a one-step pivoting movement between the first position and the second position, no further steps are required to secure the lid to the container, thereby providing easy operation for the user.

Preferably the first position is an upright position, or vertical position at substantially 90 degrees to the lid, and the second position is a horizontal position, or reclined position at substantially 180 degrees to the lid.

In one embodiment, the handle is locatable in more than one first position. More preferably the handle is locatable in two first positions. Preferably the two first positions are upright, at substantially 90 degrees to the lid, and a reclined position forward from the upright position, at substantially 0 degrees to the lid, more preferably reclined on the opposite side to the hinge between the lid and the device.

Preferably, in such an embodiment, the handle is locatable in one second position. Preferably the second position is when the handle is in a reclined position backward from the first position, at substantially 180 degrees to the lid, more preferably reclined over the hinge between the lid and the device.

In another embodiment the handle may be locatable in more than one second position. Optionally the handle may be locatable in two second positions. Optionally the two second positions are on the left and right hand sides of the container respectively, optionally located on opposite sides of the first position, at substantially 0 and 180 degrees to the lid in such an embodiment, there would only be one first position at the upright, or substantially 90 degrees to the lid, and two second positions at the horizontal or substantially 0 and 180 degrees to the lid.

Advantageously, having more than one first position in which the lid is urged onto the container allows the user to seal the device when hanging the device by the handle in the upright position, or when standing the device upon a surface such as a perch when the handle can be located forward of the upright position. This is particularly advantageous when free standing the device in that it avoids birds being able to land on the handle and inadvertently move the handle to a second position in which the container is then open.

Advantageously, having more than one second position in which the lid is removable from the container provides flexibility to the user when operating the device.

Preferably the handle is locatable only the first and the second positions, such that suitably the handle is operable between the first and second positions in a one-step motion.

Advantageously, the operation of the device is therefore smooth, quick and easy between a compressed and locked lid in the first position, and a released and open lid in the second position.

Preferably the handle comprises engaging means operable to engage the lid.

Preferably the engaging means engages the lid by bearing against or interlocking with the lid. Therefore, the engaging means preferably comprises a mutually interlocking mechanism, said mechanism having engaging elements located on the handle and on the lid, which engaging elements interact.

Preferably the engaging elements of the handle comprises a hollow cylindrical body having a wall, the wall having a cut away portion.

Preferably the cut away portion is sized such that the engaging elements of the lid can pass therethrough.

Preferably the cut away portion extends along about one third to two thirds of the circumference of the wall depending on the number of first and second positions.

In a first embodiment, where the handle is locatable in two first positions, preferably the cut away portion extends along about one third of the wall, such that there are two sealed positions.

In a second embodiment, where the handle is locatable in two second positions, preferably the cut away portion extends along about two thirds of the wall, such that there are two open positions

Preferably the handle comprises two engaging elements, preferably located on opposing portions of the handle.

Preferably the engaging elements face inwards from the handle, such that the hollow end of the cylindrical body is open to the inside of the handle.

Preferably the engaging element of the lid comprises a protrusion, preferably the lid comprises two engaging elements preferably located on and extending from opposite sides of the lid, and suitably in alignment with the engaging elements of the handle.

Preferably the two engaging elements of the lid form a pair of protrusions or ears.

Preferably the engaging elements comprise half-pipe shaped protrusions from the sides of the lid. Suitably the protrusions are sized such that they are operable to interlock with the engaging elements of the handle.

Preferably the convex side of the protrusions faces upwards from the lid.

Preferably the hollow end of the cylindrical body of the engaging elements of the handle are perpendicular to the engaging elements of the lid, such that the engaging elements are operable to engage with the cylindrical body as the handle is pivoted over the lid.

Suitably the handle is operable to be moved between the first and second positions.

Preferably as the handle moves from the second position into the first position, the handle pivots about a static pivot point, preferably said pivot point is in connection with the container. As the handle is moved about the pivot from the second to the first position, the engaging elements of the handle engage with the engaging elements of the lid.

Preferably, the engaging elements of the lid slideably engage with the enagaging elements of the handle. More preferably, as the handle moves from the second position up and over the lid to the first position, the engaging elements of the lid slide through the cut away portion of the cylindrical bodies until the engaging elements of the lid are engaged with and located within the cylindrical bodies of the handle.

Preferably at the first position, the engaging elements are located within the cylindrical bodies of the handle and are substantially in alignment with the wall of the cylindrical bodies.

Preferably the engaging elements of the handle exert pressure on the engaging elements of the lid when in the first position, preferably downward pressure from the handle onto the lid. More preferably pressure is exerted by the cylindrical wall of the engaging elements of the handle onto the engaging elements of the lid.

Preferably the pressure increases as the engaging elements of the lid slide through the cut away portion of the cylindrical bodies until a maximum pressure is reached when the engaging elements of the lid are engaged with, and suitably located within, the cylindrical bodies of the handle.

Accordingly, the engaging elements of the lid are preferably in contact with, more preferably coplanar with the engaging elements of the handle. Accordingly, the handle is preferably held in the first position by a friction fit of the engaging elements of the handle against the engaging elements of the lid.

Advantageously, at the first position, the engaging elements of the lid cannot be removed from the engaging elements of the handle by upward, downward, or lateral force as the engaging elements of the lid are contained within the engaging elements of the handle such that the only means of removal of the lid is pivoting the handle to the second position. Therefore the lid is secured to the container by the handle. Furthermore, pressure is exerted onto the lid such that the lid is firmly held on the container rather than simply resting upon the container.

Preferably the device further comprises a locking mechanism.

Preferable the locking mechanism is operable to lock the lid to the handle, more preferably to lock the engaging means of the handle to the engaging means of the lid, still more preferably to lock the cylindrical body of the handle to the engaging elements of the lid.

Preferably the locking mechanism is an interlocking system, preferably the interlocking system comprises a retaining groove and a stud. Preferably the retaining groove is located on the engaging elements of the lid and the stud is located on the engaging elements of the handle, more preferably the retaining groove is located on the engaging elements of the lid and the stud is located on the cylindrical body.

Preferably the groove and the stud are located in alignment with the first position of the handle, i.e. at the top of the engaging elements of the lid and the cylindrical body, and optionally also at substantially 0 degrees to the lid if there are two first positions, such that the locking mechanism is actuated when the handle reaches the or each first position.

Suitably the locking mechanism is actuated when the stud is located within the retaining groove.

Preferably the device comprises a plurality of such locking mechanisms, preferably operable to lock the lid to the handle as the handle is moved between the first and the second position/s. Therefore, suitably the engaging elements of the lid may comprise a plurality of retaining grooves and the engaging elements of the handle may comprise a plurality of studs.

Optionally, the locking mechanism may further comprise a ratchet.

Advantageously, the locking mechanism allows the handle to be held at the first and second position/s more securely and prevents the handle from pivoting between the positions without actuation by the user.

Preferably the engaging means comprises a further pressure inducing means for increasing pressure from the handle onto the lid. More preferably for incrementally increasing pressure onto the lid as the handle is moved between the second position to the first position, suitably to a maximum pressure at the first position.

Preferably the pressure inducing means is located within the cylindrical body of the engaging means of the handle. Preferably the pressure inducing means is a gradually increasing thickness of the wall of the cylindrical body.

Suitably therefore, the wall may act to increase the pressure on the lid as the handle moves towards the first position.

Preferably, therefore, in the first position the handle engages the lid such that the lid is compressed onto the container, and in the second position the handle disengages from the lid such that the lid is released from the container.

Advantageously, as the handle is pivoted from the second position to the first position, and the engaging elements of the lid slideably engage with the cylindrical body of the handle, increasing pressure is applied from the wall of the cylindrical body onto the upper surface of the engaging elements. This pressure is exerted downwards onto the lid via the engaging elements and forces the lid onto the container. Therefore the engagement of the lid and the handle is stronger and the seal of the lid to the container is stronger.

Suitably the device further comprises a base, preferably retained on the container by a friction fit.

Preferably the base comprises a fixing means for fixing the components of the device together. Preferably the fixing means comprises a pin, preferably located in the base and extending upwards through the container, more preferably centrally located in the base and/or container.

Preferably the fixing means comprises a latching mechanism operable to release the fixing means such that the components of the device can be separated. Preferably the latching mechanism comprises a slot and a projection. Preferably the projection is located on or connected to the fixing means, more preferably the projection is located on or connected to the pin. Preferably the slot is located within the base, more preferably the slot extends through the base.

Alternatively, the fixing means may comprise a threaded portion operable to mutually engage a threaded aperture, preferably located in the base of the device.

Preferably the fixing means further comprises an actuating means. Preferably the actuating means comprises a grip member. Preferably the grip member is located at the top of the fixing means, more preferably at the top of the pin.

Suitably the grip member is operable to be grasped by a user and rotated.

Preferably as the grip member is rotated, the fixing means and projection are also rotated until the projection meets the slot, allowing the projection to pass through the slot in the base and removed from the base and the container thereby separating the container, base, and fixing means.

Alternatively, as the grip member is rotated, the fixing means is rotated until the threaded portion is unthreaded from engagement with the threaded aperture in the base, allowing the fixing means to pass through the aperture and be removed from the base and the container thereby separating the container, base, and fixing means.

Preferably the fixing means is removed upwards through the base and out of the top of the container.

Suitably, therefore, the fixing means may also be inserted through the container into the base and in doing so the projection passes through the slot in the base, and the grip member may be counter- rotated until the projection is removed from the slot thereby locking together the container, base and fixing means. Preferably the grip member, fixing means and projection are rotated or counter-rotated by about 90 degrees during separation or locking together of the components of the device.

Alternatively, therefore, the fixing means may also be inserted through the container into the aperture in the base, and the grip member maybe counter-rotated until the threaded portion of the fixing means is fully engaged with the threaded portion in the base, thereby locking together the container, base and fixing means.

Advantageously, the fixing means is located centrally within the device and uses one component to lock all of the sections of the device together with a simple rotation. This allows the device to be completely disassembled for cleaning purposes which avoids harmful bacteria and other debris building up within the device.

Suitably the container houses the bird feed, suitably within the container there is provided a feed area in which the bird feed is stored.

Preferably the container is formed from a continuous wall.

Preferably the wall is formed from plastic or metal, preferably when the container is formed from plastic it is solid, preferably when the wall is formed from metal it is a mesh.

Preferably the device comprises a plurality of ports, preferably located in the wall of the container and suitable for allowing birds to access the bird feed contained within the container.

Suitably each of the ports comprises an aperture extending through the wall of the container.

Preferably the device comprises an arrangement of ports which is operable to balance the device when birds are standing thereon, such an arrangement may be a spiral of ports; pairs or triads or quads of ports; offset single ports etc. Preferably the device comprises pairs of ports, for example, 2, 4, or 6 ports.

Preferably the ports are located at opposite sides of the container.

Advantageously, the ports allow the birds to feed from the container, and when they are oppositely located on the container, the device is balanced.

Preferably the ports comprise annular rims, preferably the rims are formed from a gripping material, for example rubber. Suitably the annular rims are located upon the circumference of the apertures.

Preferably the annular rims are operable to be clipped into the ports.

In one embodiment, the ports may comprise a slot or mouth shape aperture extending through the wall of the container.

In such an embodiment, the ports may comprise surrounds instead of rims, preferably the surrounds are formed from a gripping material, for example rubber. Suitably the surrounds are located upon the edge of the apertures.

Preferably the surround comprises a shelf. Preferably the shelf projects outwards from the surround, perpendicular to the wall of the container. Preferably the shelf projects from a lower portion of the surround, more preferably from a lower edge of the aperture.

Optionally the shelf may further comprise a plurality of drainage holes therethrough.

Advantageously, the shelf presents some of the feed on its surface such that birds can easily access the feed from the port.

Preferably the surround comprises a porch. Preferably the porch projects outwards from the surround, substantially perpendicular to the wall of the container. Preferably the porch projects from an upper portion of the surround, more preferably from an upper edge of the aperture.

Preferably the porch extends outwards further than the shelf. More preferably, the porch substantially covers the shelf beneath.

Advantageously, the porch protects the feed displayed on the shelf below.

Preferably the surround further comprises a retaining strap, preferably the retaining strap extends from the surround and around the wall of the container to hold the surround in place. The retaining strap may therefore be formed from an elastically deformable material such as rubber.

The retaining strap may be integral with the surround, or may be attached to the surround. Preferably the retaining strap is attached to the surround by means of retaining hooks present on the surround, preferably the hooks are present at either side of the surround. Preferably the retaining strap comprises holes operable to cooperate with the retaining hooks, and into which the retaining hooks extend.

In use, the surround may be placed onto the aperture and held whilst the retaining strap is placed around the wall of the container and the retaining hooks are pushed into the holes of the retaining strap to secure the surround thereon.

Suitably the surrounds perform the same functions as the rims, all of the features discussed herein in relation to the rims may apply equally to the surrounds.

Preferably the ports further comprise stands. Preferably the stands are attached to the annular rims.

Preferably the stands are fixed to the ports, more preferably fixed to the annular rims of the ports.

Alternatively, the stands may be pivotally attached to the ports, more preferably the annular rims such that the stands are foldable. Preferably the stands are operable to be folded up against the wall of the container or down such that they project outward from the container.

Advantageously, the stands are operable to be folded away for ease of storage and transport.

Preferably the stands project outward from the container at an angle of between 90-170 degrees, more preferably between 100-150 degrees, more preferably around 120 degrees.

Preferably the stands comprise crossbars for birds to grip onto. Preferably the stands each comprise two crossbars. Preferably the first crossbar is shorter than the second crossbar.

Preferably the first crossbar is located approximately halfway up the stand and preferably the second crossbar is located at the projecting end of the stand.

Preferably the crossbars comprise a high friction surface, more preferably the crossbars are knurled.

Advantageously the high friction surface allows birds to grip the crossbars more easily.

Alternatively, the stand may comprise a hoop for birds to grip onto.

Advantageously, the hoop shape allows ground feeding birds as well as perch feeding birds to access the feed through the ports.

Suitably the hoop perform the same functions as the crossbars, all of the features discussed herein in relation to the crossbars may apply equally to the hoops.

Preferably the base further comprises dispensing means, suitably for dispensing bird feed out of the container.

Preferably the dispensing means comprises a prismatic projection, suitably projecting upward from the base into the container, suitably into the feed area of the container.

Preferably the prismatic projection comprises a triangular prism, suitably having two angled surfaces and a vertex therebetween.

Preferably the angled surfaces are angled towards the ports. Preferably the base of the angled surfaces abut the apertures of the ports.

Advantageously, the dispensing means acts to shunt feed within the container towards the ports such that feed does not become trapped on the base and such that feed is prevented from being wasted.

Preferably the lid comprises two parts. Preferably a closure and a collar.

Preferably the collar is adapted to be placed over the opening of the container, suitably to attach the lid to the container. Preferably the collar is attached to the container by a friction fit, preferably the friction fit is achieved by the collar comprising an annular groove, and suitably the annular groove is sized to receive the wall of the container.

Advantageously forming the lid of a closure and a collar allows the lid to be placed on any design of container.

Preferably the closure comprises a substantially planar member operable to cover the opening of the container and which suitably comprises the engaging means of the lid. More preferably the closure comprises a disc suitable for covering the circular opening of the cylindrical container.

Preferably the lid is attached to the container by a hinge, more preferably the closure is attached to the collar by a hinge.

Preferably the hinge is a live hinge, preferably formed from a weakened section, preferably of an elastic polymer.

Advantageously the use of a live hinge minimises the use of further components in the device, and when used between the collar and closure, allows this component to be formed from one piece, reducing manufacturing costs.

Preferably the lid is formed from a high friction material, for example a plastics or rubber material.

Preferably the handle is suitable for hanging the device, from a tree or bird stand for example. Preferably the handle comprises an arc, suitably extending from the pivot point on one side of the container to the other side of the container.

Preferably the handle is formed from plastic or metal, more preferably metal such as stainless steel for example.

According to a second aspect of the present invention there is provided a method of closing a device for feeding birds comprising the followings steps:
(a) Covering the opening of a container of the device with a lid of the device;
(b) Moving a handle of the device from a second position to a first position;

Wherein, in the first position, the handle engages the lid such that the lid is urged onto the container.

According to a third aspect of the present invention, there is provided a method of opening a device for feeding birds comprising the following steps:
(a) Moving a handle of the device from a first position to a second position;
(b) Removing a lid of the device from a container of the device;

Wherein in the second position, the handle disengages the lid such that the lid is removable from the container.

According to a fourth aspect of the present invention, there is provided a post comprising a device according to the first aspect.

According to a fifth aspect of the present invention there is provided a bird station comprising a device according to the first aspect.

Suitably the bird station may comprise a bird house, or perch.

All of the features described herein may be combined with any of the above aspects, in any combination.

### BRIEF DESCRIPTION OF THE DRAWINGS

One or more specific embodiments of the present invention will now be described with reference to the accompanying FIGS. in which:

FIG. 1 represents an isometric view of one embodiment of the device for feeding birds;

FIG. 2 represents an isometric view of a second embodiment of the device for feeding birds;

FIG. 3 represents an isometric view of a third embodiment of the device for feedings birds;

FIG. 4a represents one embodiment of the ports of the device in a folded position;

FIG. 4b represents one embodiment of the ports of the device in a deployed position;

FIG. 5 represents a further isometric view of the device of FIG. 2;

FIG. 6 represents a partial isometric view of the device of FIG. 2.

FIG. 7 A represents a side view of a further embodiment of the ports of the device

FIG. 7B represents a front view of a further embodiment of the ports of the device

### DETAILED DESCRIPTION

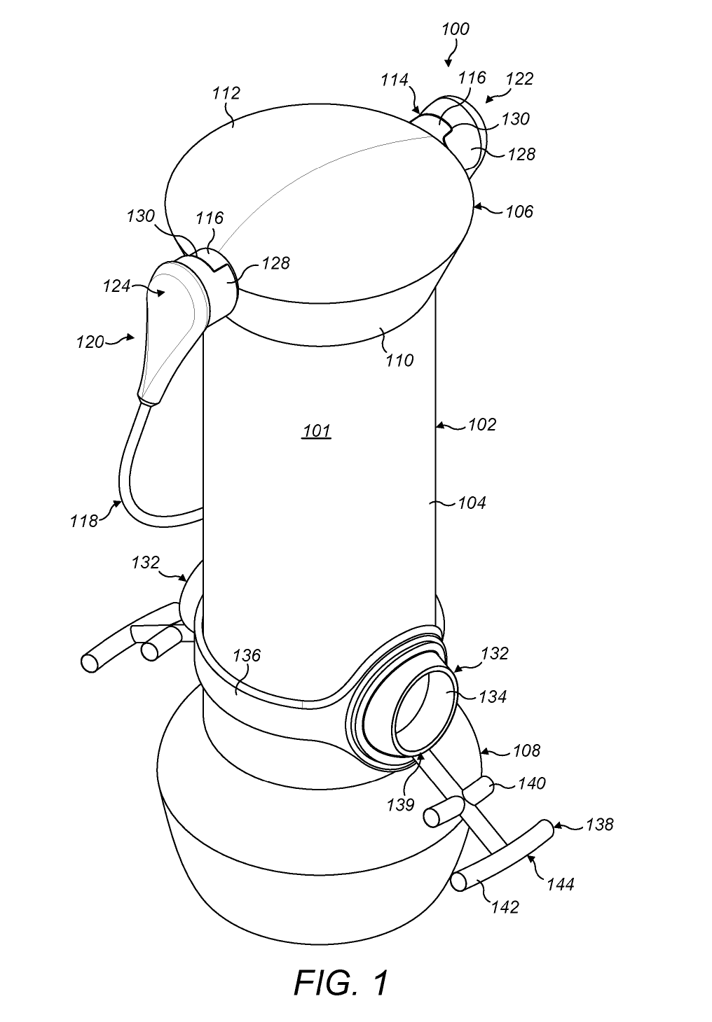

Referring to FIG. 1, there is shown a device for feeding birds 100 comprising a container 102 which comprises a cylindrical hollow body 104 formed from transparent plastics material, the container 102 is centrally located in the device 100, at the top of the container 102, there is located the lid 106, and at the bottom of the container 102 is located the base 108. The container 102 comprises a feed area 101 within its hollow body 104 for containing the bird feed.

The lid 106 comprises a collar 110, annularly disposed upon the top edge of the cylindrical body 104 of the container 102, and a closure 112, comprising a disc shaped flap operable to rest upon the collar 110 and close the container 102. The closure 112 is attached to the collar by a live hinge (not visible) located at one edge of the closure 112. The lid 106 further comprises engaging means 114 in the form of engaging elements 116 oppositely located on either side of the closure 112 of the lid 106 and each comprising a half-pipe shaped protrusion.

The base 108 is also annularly disposed upon the bottom edge of the cylindrical body 104 of the container 102.

The device 100 further comprises a handle 118 in the form of an arcuate metal loop extending from a first side 120 of the container 102 to an oppositely located second side of the container 122 and attached to the container 102 by a pivot point 124 on either side thereof. In this embodiment, the pivot points 124 extend through the collar 110 of the lid 106 into the container 102. The handle 118 comprises engaging means 126 comprising a pair of engaging elements in the form of hollow cylindrical bodies 128 inwardly facing each other from the handle 118 and approximately located on the handle 118 such that they are aligned with and operable to engage with the engaging means 114 of the lid 106. The hollow cylindrical bodies 128 comprise a wall which comprises a cut away portion 130 extending for around two thirds of the circumference of the wall and which is operable to allow the engaging means 114 of the lid 106 to pass therethrough.

The device 100 further comprises a first pair of ports 132 comprising apertures which extend through the wall of the container 102 and allow access to the feed contained therein. The ports 132 are oppositely located in the wall of the container 102 and comprise annular rims 134 disposed at the edges of the apertures. The annular rims 134 comprise a belt 136 which connects the rims 134 around the circumference of the container 102. Each port 132 further comprises a stand 138 outwardly extending from the annular rim 134 at a 120 degree angle to the container 102. The stands 138 are pivotally connected to the rims 134 of the ports 132 at their innermost ends 139. Each stand 138 comprises a first crossbar 140 and a second crossbar 142 extending perpendicular from the stand 138. The first crossbar 140 is located halfway up the stand 138 and the second crossbar 142 is located at the outermost end 144 of the stand 138.

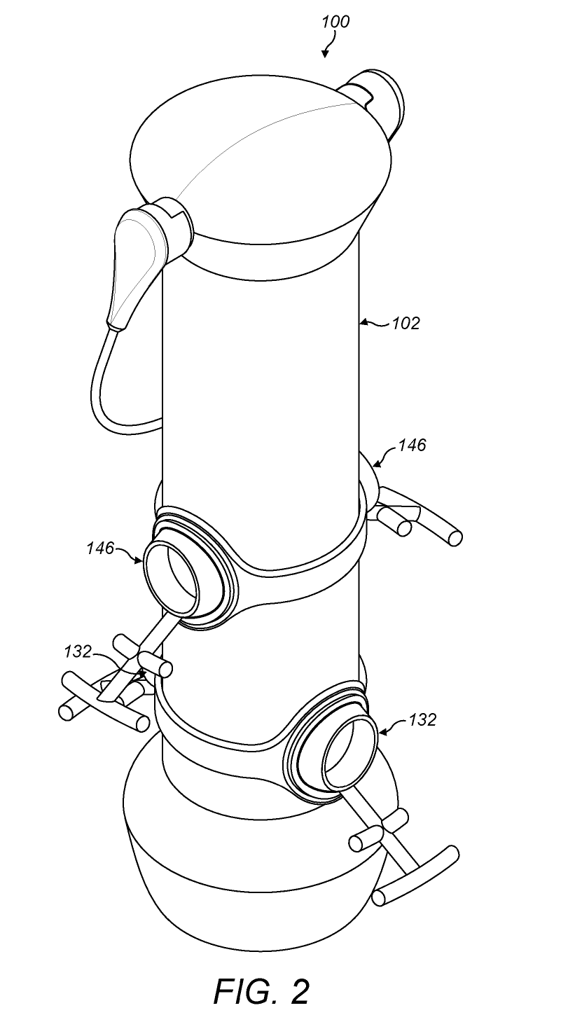

Referring now to FIG. 2, there is shown the device 100 of FIG. 1 further comprising a second pair of ports 146 located above the first pair of ports 132 in the wall of the container 102. The second pair of ports 146 are substantially the same as the first pair of ports 132 except that the first pair of ports 132 are disposed at 90 degrees of rotation to the first pair of ports 132 such that the stands 138 extending from the ports 132, 146 form a cross shape when viewed from above the container 102.

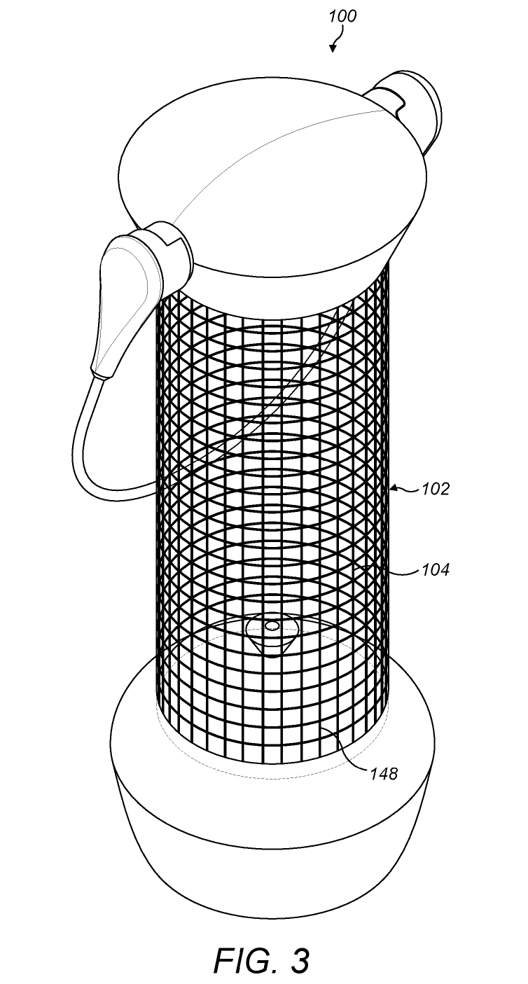

Referring now to FIG. 3, there is shown the device 100 of FIG. 1 comprising a container 102 except the cylindrical hollow body 104 of the container 102 is formed from a mesh 148 comprising a grid of metal wire. The mesh 148 allows access to the feed area 101 within the hollow body 104 of the container 102 for containing the bird feed from all sides of the container 102. In this embodiment, the container 102 does not comprise any ports 132, 146 in the walls thereof.

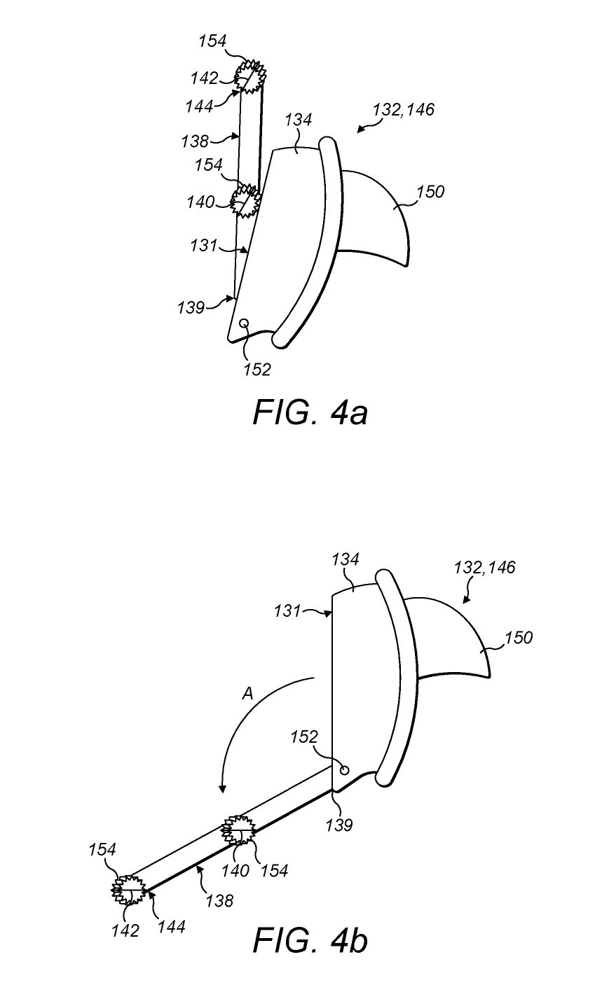

Referring now to FIGS. 4a and 4b, there is shown a port 132,146 of the device 100. The port 132, 146 comprising an annular rim 134 disposed at the circumferential edge of the port 132, 146. The annular rim 134 extends through the aperture 131 of the container 102 and into the feed area (not shown) of the container. The annular rim 134 is formed from an elastomeric material and is operable to be snapped into the aperture 131 of the container 102 in which it is held by a friction fit with the wall of the container 102. The annular rim 134 further comprises a hood 150 extending from the upper half of the annular rim 134 and forming a quarter-spherical extension from the port 132,124 into the feed area (not shown) of the container 102. The port 132, 146 comprises a stand 138 outwardly extending from the bottom portion of the annular rim 134 at a 120 degree angle to the container 102. The stand 138 is pivotally connected to the rim 134 at the innermost end 139 by a pivot point 152. Each stand 138 comprises a first crossbar 140 and a second crossbar 142 extending perpendicular from the stand 138. The first crossbar 140 is located halfway up the stand 138 and the second crossbar 142 is located at the outermost end 144 of the stand 138. The crossbars 140,142 comprise knurled surfaces 154 for birds to grip onto when feeding from the port 132,146.

During storage or transport, the stand 138 is operable to be pivoted upwards about the pivot point 152 to an upright position as shown in FIG. 4a where the stand 138 is upwardly extending from the bottom portion of the annular rim 134 at a 30 degree angle to the container 102, and is substantially flat against the container 102. During use, the stand 138 is operable to be pivoted downwards about the pivot point 152 to an outward position as shown in FIG. 4b by arrow A, where the stand 138 is extending from the bottom portion of the annular rim 134 at a 120 degree angle to the container 102.

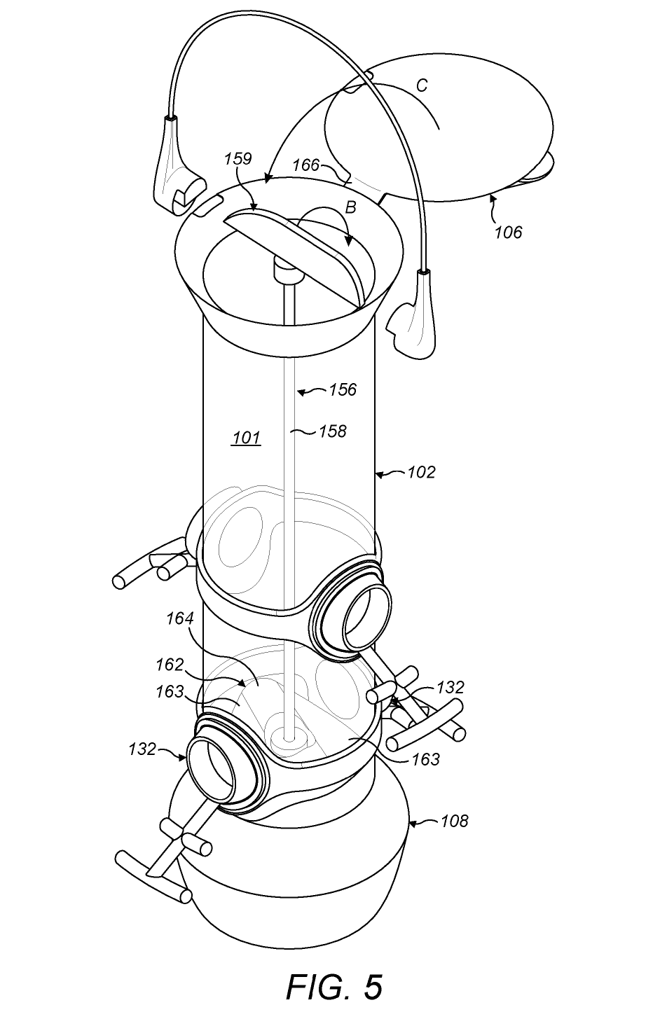

Referring now to FIG. 5, there is shown the device of FIG. 2 further comprising fixing means 156. The fixing means 156 comprises a pin 158 centrally located in the base 108 and extending upwards through the feed area 101 of the container 102. The fixing means 156 further comprises a latching mechanism (not shown) operable to release the fixing means 156 such that the components of the device can be separated. The latching mechanism (not shown) comprises a slot (not shown) and a projection (not shown). The projection (not shown) is located on the pin 158 and the slot (not shown) extends vertically through the base 108. The fixing means 156 further comprises an actuating means 159. The actuating means 159 comprises a grip member 160 which is located at the top of pin 158 proximal to the opening of the container 102 and located just underneath the lid 106.

In use, the grip member 160 is operable to be grasped by a user and rotated in the direction shown by arrow B, as the grip member 160 is rotated, the pin 158 and projection therefrom (not shown) are also rotated until the projection (not shown) meets the slot (not shown), allowing the projection to pass through the slot (not shown) in the base 108, and the pin 158 to be removed from the base 108 and the container 102 out through the lid 106 at the top of the container 102. Thereby separating the container 102, base 108, and fixing means 156.

FIG. 5 further shows a dispensing means 162 which comprises a prismatic projection upward from the base 108 into the feed are 101 of the container 102. In this case, the prismatic projection comprises a triangular prism, suitably having two angled surfaces 163 extending to the edges of the container 102, and a rounded vertex 164 therebetween located approximately in the centre of the container 102. The angled surfaces 163 are angled towards the first pair of ports 132 located in the wall of the container 102.

In use, the device 100 is operable to be closed and opened by the interlocking mechanism of the handle 118 and the lid 106.

To close the device 100, the handle 118 starts in the second position in which it is flat or lateral to the container 102, as seen in FIG. 1, the lid 106 is first closed by pushing the closure 112 up and over the collar 110, seen in FIG. 5 as arrow C, via actuation of the live hinge, seen in FIG. 5 as numeral 166, such that the closure 112 is laid on top of the collar 110, covering the opening of the container 102. The handle 118 is then rotated upwards to the first position shown in FIG. 5 and in doing so, the engaging means of the handle 126 engage and interlock with the engaging means of the lid 114. This is achieved by the engaging elements 116 of the lid 106 sliding through the cut away portion 130 such that the half-pipe shape protrusions of the engaging elements 116 sit within the hollow cylindrical bodies 128 of the handle 118. As the handle 118 is rotated upwards, the hollow cylindrical bodies 128 gradually further engage with the engaging elements 116 and exert downward pressure on the engaging elements 116, thereby compressing the lid 106 onto the container 102 via the collar. When the handle 118 reaches the upright first position, the engaging elements 116 are completely engaged with and located within the hollow cylindrical bodies 128 such that they cannot be removed by any lateral or upwards force.

To open the device 100, the handle 118 starts in the first position which is upright or vertical to the container 102, as seen in FIG. 5, the handle 118 is then rotated forwards or backwards towards a lateral or flat second position on either side of the container 102 as seen in FIG. 1. As the handle 118 is rotated, the engaging means of the handle 126 disengage and release the engaging means of the lid 114. This is achieved by the engaging elements 116 of the lid 106 sliding through the cut away portion 130 such that the half-pipe shape protrusions of the engaging elements 116 emerge from the hollow cylindrical bodies 128 of the handle 118 as the hollow cylindrical bodies 128 of the handle 118 are rotated and slid over the engaging elements 116 of the lid 106. As the handle 118 is rotated downwards, the hollow cylindrical bodies 128 gradually disengage with the engaging elements 116 and release the pressure on the engaging elements 116, thereby releasing the lid 106 from the container 102. When the handle 118 reaches the lateral second position, the engaging elements 116 are completely disengaged with and removed from the hollow cylindrical bodies 128 such that the lid 106 can be removed from the container 102. The closure 112 of the lid 106 can then be flipped up and off the collar 110 via the live hinge 166, leaving the opening of the container 102 exposed.

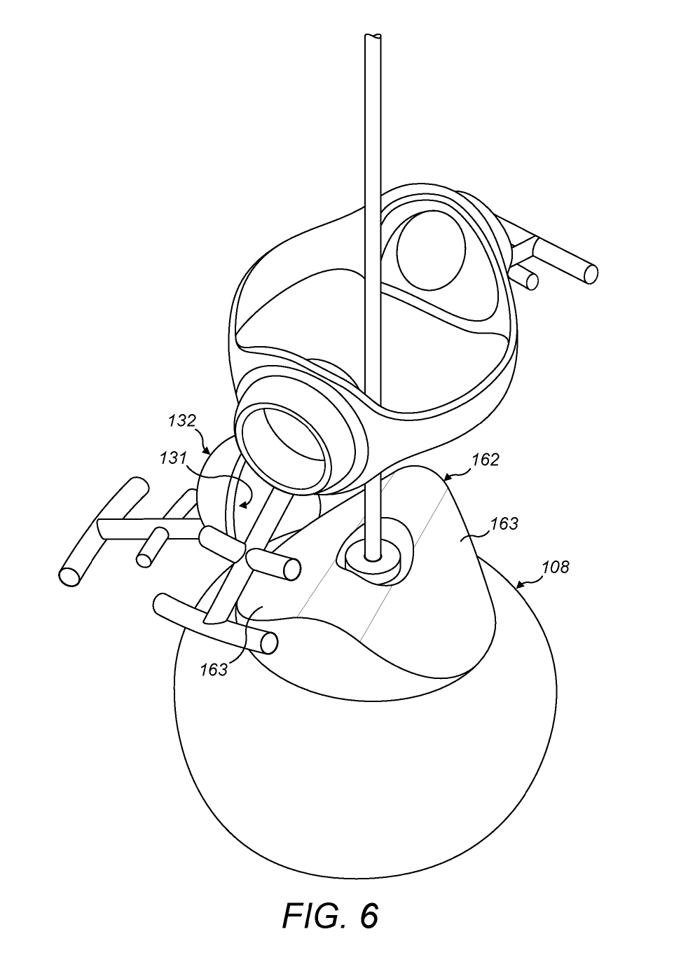

Referring to FIG. 6, there is shown the device of FIG. 2, in which the container 102 is removed and one of the first pair of ports 132 is removed, where the base 108 of the device 100 can be seen more easily. In particular, the dispensing means 162 is shown in more detail. It can be seen that the angled surfaces 163 of the dispensing means 162 are angled towards the first pair of ports 132 located in the wall of the container 102 such that the angled surfaces 163 abut the aperture 131 of the wall of the container 102.

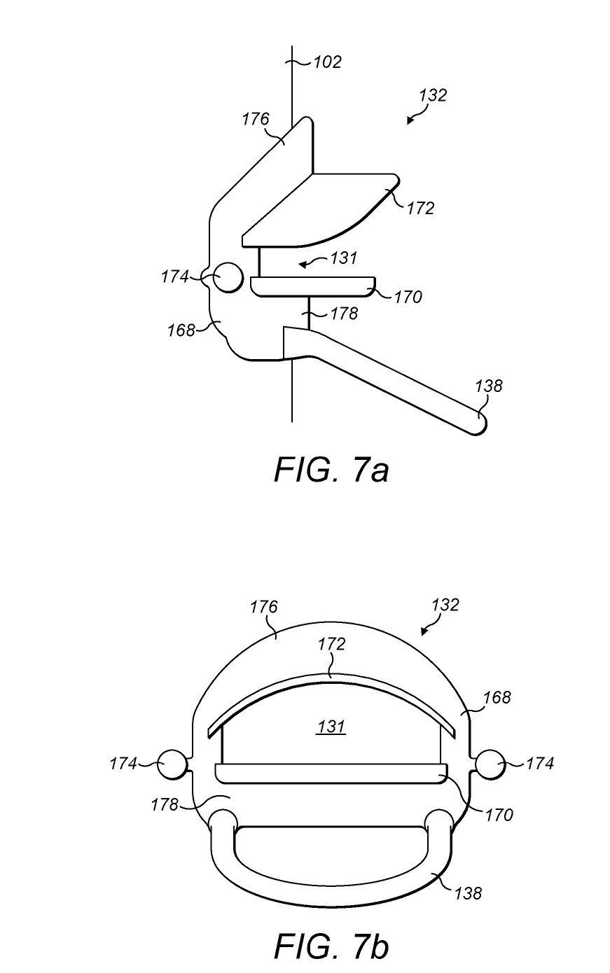

Referring to FIGS. 7A and 7B, there is shown an alternative embodiment of a port 132 comprising an aperture 131 extending through the wall of the container 102 and into the feed area of the container. The aperture is mouth shaped and is surrounded at the edge by a surround 168 formed of an elastomeric material and operable to be snapped into the aperture 131 of the container 102 in which it is held by a friction fit with the wall of the container 102.

The surround 168 comprises a shelf 170 and a porch 172. The shelf 170 and the porch 172 are both formed by projections of material integral with the surround 168 and which project outward from the surround 168. The shelf 170 and the porch 172 extend outwards from the surround 168 substantially perpendicular to the wall of the container 103. The shelf 170 comprises a planar semi-circular shape. The porch 172 comprises an arcuate rectangular shape. The porch 172 is arched or arcuate and extends around a top portion 176 of the surround 168, and the shelf 170 is planar and extends along a bottom portion 178 of the surround 168. The porch 172 and the shelf 170 act to shelter the aperture 131 therebetween. The porch 172 extends outwardly further from the wall of the container 102 than the shelf 170 such that the shelf 170 is protected beneath the porch 172.

The surround 168 further comprises a pair of retaining hooks 174 positioned on either side of the aperture 131. The hooks 174 are aligned with each other and the centre of the aperture 131 and are operable to engage with holes in a retaining strap (not shown). In use, the retaining strap (not shown) is hooked through the holes present at either end thereof onto the retaining hooks 174 to form a loop in which the container 102 of the birdfeeder 100 is placed. The retaining strap (not shown) thereby holds the surround 168 in place upon the aperture 131 by bracing the surround 168 against the container 102. The surround further comprises a stand 138 outwardly extending from the bottom portion 178 of the surround at a 120 degree angle to the container 102. The stand 138 comprises a continuous loop running from one side of the surround 168 to the other beneath the shelf 170.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A birdfeeder comprising a container, a handle and a lid, the handle being pivotally connected to the container and having a first position and a second position, wherein in the first position the handle engages the lid such that the lid is urged onto the container, and in the second position the handle disengages from the lid such that the lid is removable from the container, wherein the handle is operable between the first and second positions in a one-step motion.

2. A birdfeeder according to claim 1, wherein the first position is an upright position, and the second position is a reclined position.

3. A birdfeeder according to claim 1, wherein the handle is locatable in two first positions.

4. A birdfeeder according to claim 3, wherein the two first positions are upright, at substantially 90 degrees to the lid, and a reclined position forward from the upright position, at substantially 0 degrees to the lid.

5. (canceled)

6. A birdfeeder according to claim 4, wherein the second position is when the handle is in a reclined position backward from the first position, at substantially 180 degrees to the lid.

7 (canceled)

8. A birdfeeder according to claim 1, wherein the handle and lid include an engaging means operable to engage the lid with the handle, wherein the engaging means includes a mutually interlocking mechanism, said manually interlocking mechanism having an engaging element located on the handle and an engagement element on the lid, which engaging elements interact.

9. (canceled)

10. A birdfeeder according to claim 8, wherein the engaging element of the handle comprises a hollow cylindrical body having a wall, the wall having a cut away portion.

11. A birdfeeder according to claim 8 , wherein the engaging element of the lid comprises a protrusion in alignment with the engaging element of the handle.

12. A birdfeeder according to claim 10, wherein an end of the hollow cylindrical body of the engaging element of the handle is perpendicular to the engaging element of the lid, such that the engaging element of the lid is operable to engage with the hollow cylindrical body as the handle is pivoted over the lid.

13. A birdfeeder according to claim 10, wherein the engaging element of the lid slides through the cut away portion of the hollow cylindrical body until the engaging element of the lid is engaged with and located within the hollow cylindrical body of the handle.

14. A birdfeeder according to claim 8, wherein the engaging element of the handle exerts pressure on the engaging element of the lid when in the first position.

15. A birdfeeder according to claim 14, wherein the pressure increases as the engaging element of the lid slides through the cut away portion of the hollow cylindrical body until a maximum pressure is reached when the engaging element of the lid is engaged with, and suitably located within, the hollow cylindrical body of the handle.

16. A birdfeeder according to claim 8, wherein the birdfeeder further comprises a locking mechanism operable to lock the lid to the handle, wherein the locking mechanism includes an interlocking system comprising a retaining groove and a stud.

17. (canceled)

18. A birdfeeder according to claim 16, wherein the retaining groove is located on the engaging element of the lid and the stud is located on the engaging element of the handle.

19. (canceled)

20. A birdfeeder according to claim 18, wherein the engaging means comprises a further pressure inducing means for increasing pressure from the handle onto the lid as the handle is moved between the second position to the first position, wherein the pressure inducing means is a gradually increasing thickness of the wall of the hollow cylindrical body.

21. (canceled)

22. A birdfeeder according to claim 1, wherein in the first position the handle engages the lid such that the lid is compressed onto the container, and in the second position the handle disengages from the lid such that the lid is released from the container.

23. A birdfeeder according to claim 1, wherein the birdfeeder further comprises a base, wherein the base comprises a fixing means for fixing the components of the birdfeeder together and wherein the fixing means is a pin located in the base and extending upwards through the container.

24. (canceled)

25. (canceled)

26. A birdfeeder according to claim 23, wherein the fixing means comprises a latching mechanism operable to release the fixing means such that the components of the birdfeeder can be separated, wherein the latching mechanism comprises a slot and a projection, wherein the projection is located on or connected to the pin and the slot extends through the base.

27. (canceled)

28. A birdfeeder according to claim 1, wherein the birdfeeder comprises a plurality of ports located in a wall of the container and suitable for allowing birds to access bird feed when contained within the container, wherein the ports further comprise stands, and wherein the stands are pivotally attached to the ports such that the stands are operable to be folded up against the wall of the container or down such that they project outward from the container.

29. (canceled)

30. (canceled)

31. A birdfeeder according to claim 1, wherein the birdfeeder further includes a base, wherein the base further comprises a dispensing means, wherein the dispensing means comprises a prismatic projection, the prismatic projection projecting upward from the base into the container.

32. (canceled)

33. (canceled)

34. A birdfeeder according to claim 1, wherein the lid comprises two parts: a closure and a collar, wherein the collar is adapted to be placed over an opening of the container to attach the lid to the container.

35. (canceled)

36. A method of closing a birdfeeder, the birdfeeder including a container, a handle and a lid, the handle being pivotally connected to the container and having a first position and a second position, wherein in the first position the handle engages the lid such that the lid is urged onto the container, and in the second position the handle disengages from the lid such that the lid is removable from the container, wherein the handle is operable between the first and second positions in a one-step motion, the method comprising the following steps:
(a) covering the opening of the container of the birdfeeder with the lid of the birdfeeder;
(b) moving the handle of the birdfeeder from a second position to a first position;
wherein, in the first position, the handle engages the lid such that the lid is urged onto the container.

37. A method of opening birdfeeder, the birdfeeder including a container, a handle and a lid, the handle being pivotally connected to the container and having a first position and a second position, wherein in the first position the handle engages the lid such that the lid is urged onto the container, and in the second position the handle disengages from the lid such that the lid is removable from the container, wherein the handle is operable between the first and second positions in a one-step motion, the method comprising the following steps:
(a) moving the handle of the birdfeeder from a first position to a second position;
(b) removing the lid of the birdfeeder from the container of the birdfeeder;
wherein in the second position, the handle disengages the lid such that the lid is removable from the container.

38. A birdfeeder according to claim 1, wherein the birdfeeder is a part of a post.

39. A birdfeeder according to claim 1, wherein the birdfeeder is a part of a bird station.

40. (canceled)
